(19) United States
(12) Patent Application Publication
(10) Pub. No.: US 2025/0301181 A1
(43) Pub. Date: Sep. 25, 2025

(54) METHODS AND APPARATUSES FOR FILM GRAIN MODELING

(71) Applicant: InterDigital CE Patent Holdings, SAS, Paris (FR)

(72) Inventors: Frederic Lefebvre, Rennes (FR); Franck Galpin, Thorigne-Fouillard (FR); Claire-Helene Demarty, Montreuil-le-Gast (FR); Zoubida Ameur, Cesson-Sevigne (FR)

(21) Appl. No.: 18/863,071

(22) PCT Filed: May 2, 2023
(86) PCT No.: PCT/EP2023/061474

§ 371 Date: Nov. 5, 2024

(30) Foreign Application Priority Data
May 5, 2022 (EP) 22305671.4

(51) Int. Cl. H04N 19/86; H04N 19/11; H04N 19/124; H04N 19/136; H04N 19/184; H04N 19/593

(52) U.S. Cl. CPC H04N 19/86; H04N 19/11; H04N 19/124; H04N 19/136; H04N 19/184; H04N 19/593

(57) ABSTRACT

A method and an apparatus for selecting regions used for film grain modeling are provided. A reconstructed image is obtained from an encoding of an input image. At least one region of the reconstructed image is selected based on at least one coding parameter of the region when encoding the input image, and film grain parameters are determined from the at least one region selected and the input image.

### CROSS REFERENCE TO RELATED APPLICATIONS

This application claims the priority to European Application No. 22305671.4, filed on 5 May 2022, which is incorporated herein by reference in its entirety.

### TECHNICAL FIELD

The present embodiments generally relate to video compression, distribution and rendering, and more particularly to film grain modeling. The present embodiments relate to a method and an apparatus for detecting uniform regions used for film grain modeling.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

Film grain is a specific type of noise which appears in video which is very pleasant and very distinctive. In its essence, film grain is a result of physical processes of analog film stock exposure and development. Originally a noise due to the process of photography, the so-called film grain, consisted in to a sensor noise, naturally present and unique for each analog camera. With the era of digital cameras, this sensor noise has disappeared at the capture stage but is now added afterwards to the content to recreate a movie look. The random nature of this noise makes it difficult to compress using traditional coding tools. The common parameters of the encoding tools, such as those chosen for low bit rates, often remove film grain. High bitrates are required to keep and reconstruct film grain with sufficient quality, which is contrary to the encoding/decoding goal of saving bits while encoding content. To overcome this encoder filtering issue, usually, film grain modeling is performed before the encoding stage and the film grain is added back to the reconstructed video using the model of the film grain, during a so-called synthesis step, at the decoding stage.

### SUMMARY

According to an aspect, a method for selecting regions used for film grain modeling is provided. The method comprises obtaining a reconstructed image from an encoding of an input image, selecting at least one region of the reconstructed image wherein selecting the at least one region of the reconstructed image is based on at least one coding parameter of the region when encoding the input image, and determining film grain parameters from the at least one region selected and the input image.

According to another aspect, an apparatus for selecting regions used for film grain modeling is provided. The apparatus comprises one or more processors that is operable to obtain a reconstructed image from an encoding of an input image, select at least one region of the reconstructed image based on at least one coding parameter of the region when encoding the input image, and determine film grain parameters from the at least one region selected and the input image.

One or more embodiments also provide a computer program comprising instructions which when executed by one or more processors cause the one or more processors to perform the method for selecting regions used for film grain modeling according to any of the embodiments described herein. One or more of the present embodiments also provide a computer readable storage medium having stored thereon instructions for selecting regions used for film grain modeling according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates examples of block partitioning.

FIG. 5 illustrates an example of a method for film grain encoding/decoding.

FIG. 6 illustrates an example of a method for encoding/decoding a video content with film grain modeling.

FIG. 7 illustrates an example of a method for encoding/decoding a video content with film grain modeling, according to an embodiment.

FIG. 8 illustrates an example of a method for determining film grain parameters according to an embodiment.

FIG. 9 illustrates an example of a method for determining regions used for determining film grain parameters according to an embodiment.

FIG. 10 illustrates an example of partitioning driven block selection for QP22 (top) and QP (32) bottom.

FIG. 11 illustrates an example of intra mode driven block selection based on planar mode (top) and DC mode (bottom).

FIG. 12 illustrates an example of residuals driven block selection based on a code block flag value.

FIG. 13 illustrates an example of cost driven block selection based on a bpp cost lower than a given value.

FIG. 14 illustrates a block diagram of a system within which aspects of the present embodiments may be implemented, according to another embodiment.

FIG. 15 shows two remote devices communicating over a communication network in accordance with an example of the present principles.

FIG. 16 shows the syntax of a signal in accordance with an example of the present principles.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

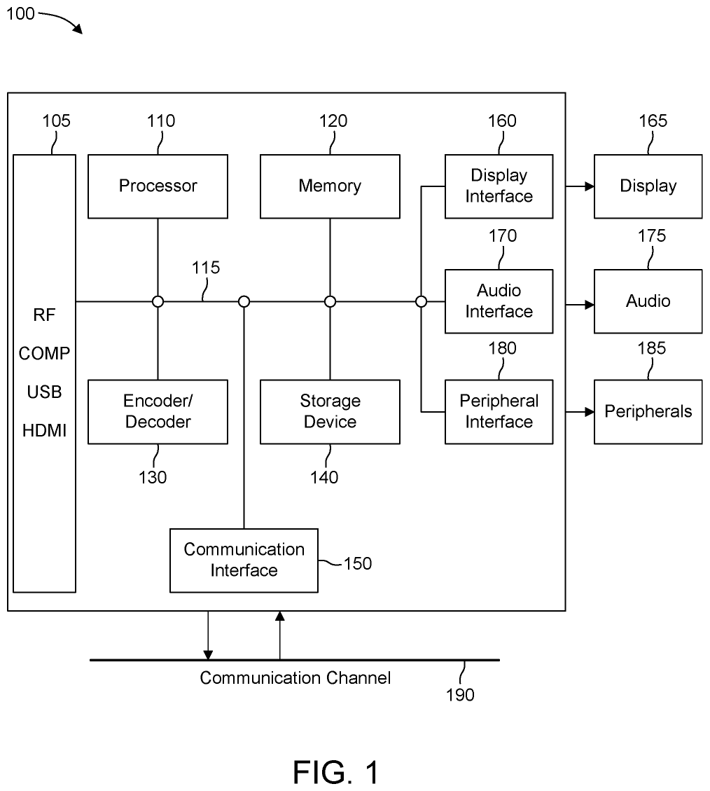

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded.

These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the 12C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

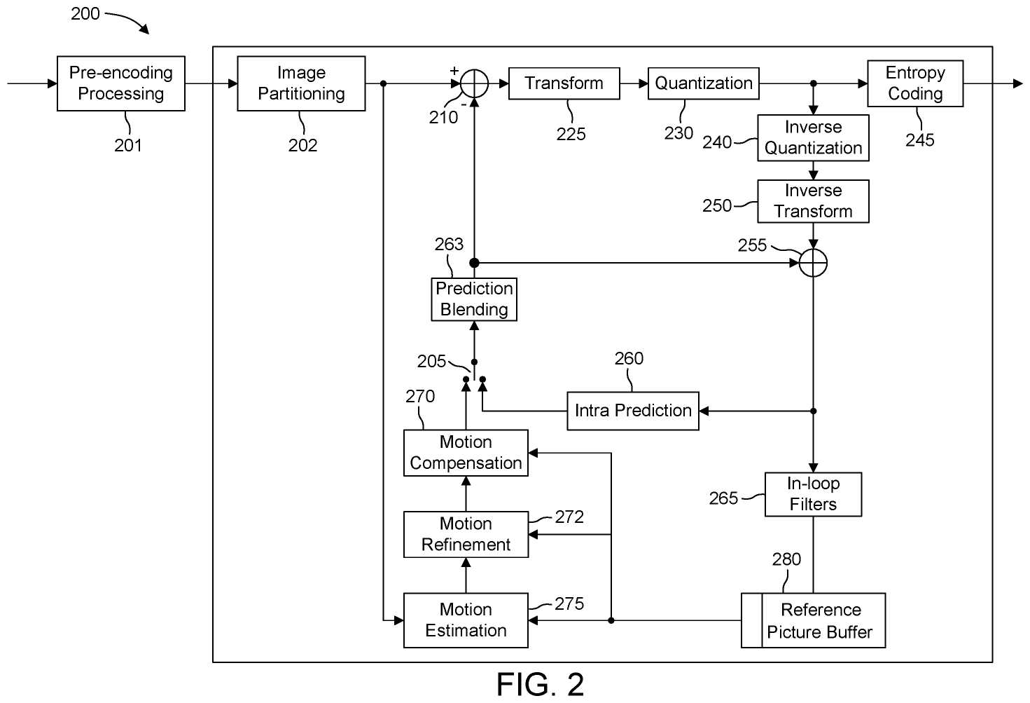

FIG. 2 illustrates an encoder 200. Variations of this encoder 200 are contemplated, but the encoder 200 is described below for purposes of clarity without describing all expected variations.

In some embodiments, FIG. 2 also illustrate an encoder in which improvements are made to the HEVC standard or a VVC standard or an encoder employing technologies similar to HEVC or VVC, such as an encoder under development by JVET (Joint Video Exploration Team).

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of color components), or re-sizing the picture (ex: down-scaling). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods. Prediction residuals are calculated, for example, by subtracting (210) the predicted block from the original image block.

The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

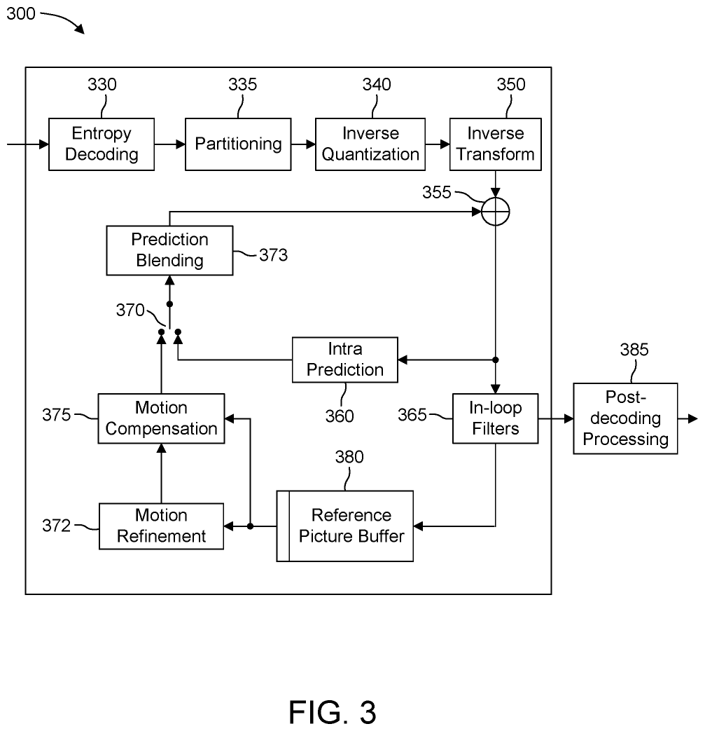

FIG. 3 illustrates a block diagram of a video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201), or re-sizing the reconstructed pictures (ex: up-scaling). The post-decoding processing can use metadata derived in the pre-encoding processing and signaled in the bitstream.

### Block Partitioning Structure

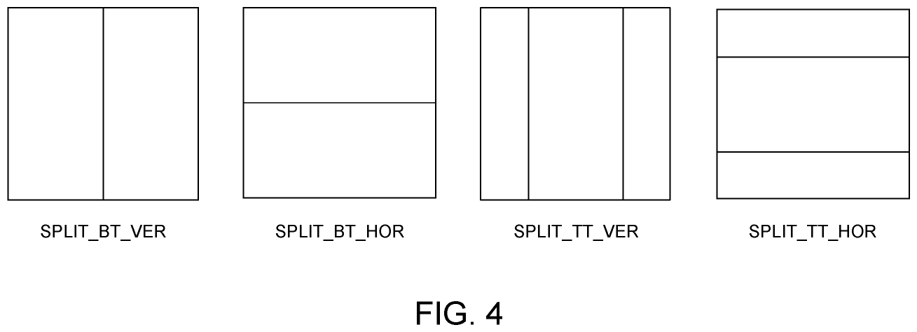

In VVC, one picture is divided or partitioned into multiple non-overlapping Coding Tree Units (CTU). A CTU size in VVC can be set up to 128×128 for luma samples. Each coding tree unit (CTU) is either processed as one coding unit or split into multiple coding units (CUs) by one or more recursive quaternary tree (QTBT) partitions followed by one or more recursive multi-type tree splits, such as Binary Tree (BT) or Ternary Tree (TT). The latter can be horizontal binary tree split (SPLIT_BT_HOR), vertical binary tree split (SPLIT_BT_VER), horizontal ternary tree split (SPLIT_TT_HOR), or vertical ternary tree split (SPLIT_TT_VER) as illustrated in FIG. 4. A CTU dual tree for intra-coded slices is described on top of the block partitioning structure, that separates coding trees for luma and chroma. The splits (QTBT, BT or TT), applied to each CTU, resulting in one or multiple CUs, have square and rectangular shapes. They allow for a better fit to local picture content characteristics and features.

By increasing the CTU size up to 128×128 for luma, the coding efficiency is improved but at the expense of increasing the complexity. The size of each CU is related to the information present in this CU, and more precisely is related to the rate distortion (RD) cost of the CU. The rate distortion (RD) cost of a candidate block can be calculated as follows:

$$CostRD = D + Lambda ( QP ) \times R$$

where D is the distortion (for example an L2, i.e., Euclidean distance) of the current block with its coding parameters, R is the associated rate (in number of coding bits) and Lambda (QP) is the Lagrange parameter deduced from the quantization parameter QP. High QP generates less but larger CUs than small QP. Once the partitioning is completed during the coding stage, several features are available for intra frames and for each CU such as follows. An intra prediction mode indicates which prediction mode is used, for example a planar or an angular prediction. A code block flag (CBF) indicates if residuals are added on top of the prediction. The CBF flag is coded per components. The bit per pixel cost (bpp) can be extracted by an encoder during the encoding stage. The DCT transformed coefficients can also be used, these are values of the transformed and quantized coefficients. A significance flag and last x y can be used. These parameters signal which coding groups inside a Transform Unit contains coefficients.

### Film Grain Modeling

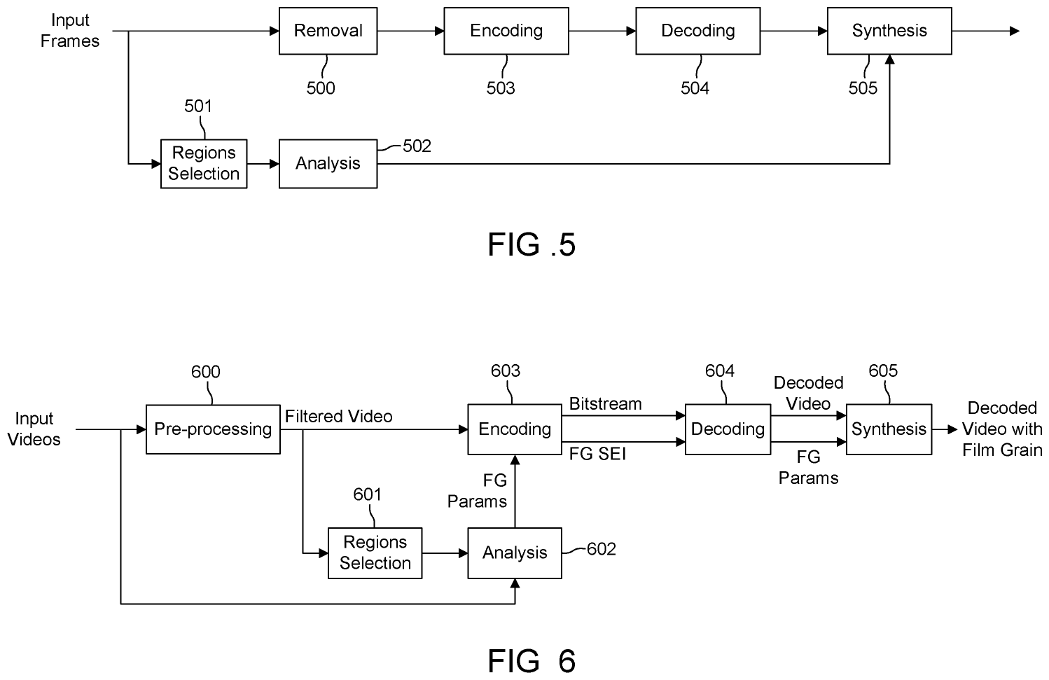

Modern video compression and distribution systems can provide a mechanism to remove film grain prior to and/or during the compression and add it back at the user side in a controllable manner automatically by using parametric models. FIG. 5 illustrates a block diagram of an example of a film grain usage in a video coding framework. Typically, encoders remove the original film grain from a video (500) and estimate the film grain model parameters based on uniform region selection (501) and analysis of the original content (502).

For film grain estimation, uniform regions in the image are detected. The common techniques used to detect uniform regions comprise applying some prefiltering such as denoiser, or edge detection, out of the encoding process. It is an overhead for the encoding stage as the uniform region detection is an additional process to perform after the pre-processing of the frame to remove the film grain of the input video and the encoding of the frame. It is CPU and memory consuming.

In the framework illustrated on FIG. 5, the content without the film grain is encoded (503) and transmitted to a decoder that decodes the transmitted content (504) and replaces (505) the removed film grain with a synthetic alternative that is visually close to the removed one. In such a way, information on film grain is communicated as an additional metadata as illustrated in an embodiment by FIG. 6 showing a block diagram of an example of a film grain usage in a video coding framework according to another example. As explained above with FIG. 5, there are two stages in film grain preservation: modeling (regions selection and analysis) and synthesis. Embodiments presented herein focus on the modeling and more precisely on the grain analysis/noise extraction from the original content. As illustrated in FIG. 6, the grain analysis uses the original frame with grain (Input video) and the corresponding filtered frame without film grain (Filtered video). This filtered frame is obtained via a denoising step (600 Pre-processing). From the filtered frame, flat regions are then extracted (601) as they will serve as a mask to estimate the grain parameters in the grain layer (602), which is determined as the difference between the original frame and its filtered version. The filtered frames are encoded (603).

Once estimated, the grain parameters (FG params) are sent along with the compressed video bitstream, for instance in an SEI message (FG SEI). After the decoding (604), the film grain is synthesized from the film grain parameters (605) and added back to the reconstructed video frames.

For determining film grain parameters, denoising and flat region detection are used in grain analysis.

Many approaches address film grain removal, ranging from using a video encoder as denoiser to a Wiener type filter, non-linear denoising with total variation minimization and multi-hypothesis motion compensated filtering. MCTF (Motion Compensated Temporal Filtering), a video filtering tool in VVC, is also an efficient denoiser. Once denoising is applied, flat regions are estimated such that only flat/uniform/smooth regions of the picture are used in the estimation, since edges and textures can affect estimation of the film grain strength and pattern. To determine smooth areas of the picture, the Canny edge detector is often applied to the denoised image at different scales, followed by a dilation operation.

It can be seen that the above methods rely on additional process to extract the film grain parameters, which might not be suitable for very low complexity/latency encoders.

In the examples illustrated in FIG. 5 and FIG. 6, the workflow of legacy solutions can be summed up as follows. Film grain analysis and extraction are done outside of the codec workflow. Film grain parameters are sent (typically using a SEI message) to the decoder. A synthetizer puts back film grain on the reconstructed image to display.

According to an embodiment, a method and an apparatus are provided for determining film grain parameters leveraging the encoding process results. This allows performing fast and reliable film grain parameters extraction by selecting regions based on coding parameters obtained during encoding of the input frames.

In an embodiment, only intra coded frames are considered for region selection.

In another embodiment, regions are selected based on the coding unit (CU) partitioning for Intra frame during the encoding.

In some embodiments, flat regions can be selected by analyzing relevant information for each CU from a CTU luma, considering for instance at least one of the following parameters or a combination of parameters: QP, Coding Unit (CU) size, intra prediction mode (MPI, DC, planar, angular), Code Block Flag (CBF) OFF or ON, Bit Per Pixel (BPP) cost, Last_xy_sig, DCT coefficient distribution.

In this way, the uniform region detection for film grain determination is accelerated and improved.

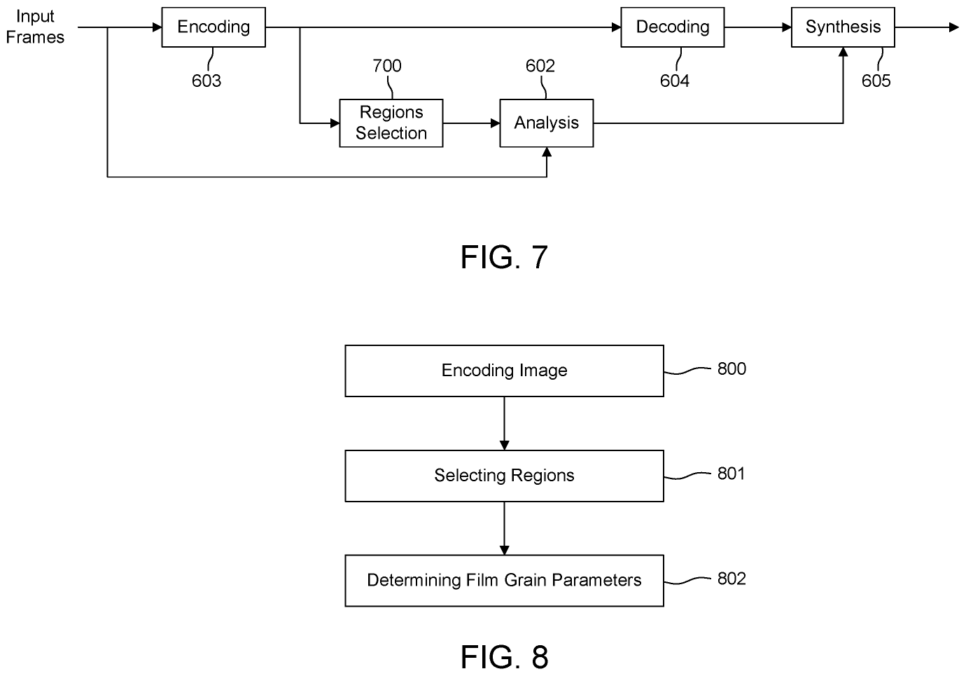

FIG. 7 illustrates an example of a method for encoding/decoding a video content with film grain modeling, according to an embodiment. In this embodiment, steps 602-605 are similar to the one explained with FIG. 6, except that the encoding of the input frame (603) replaces the pre-processing (600) of the input image of FIG. 6. According to the embodiment presented herein, the encoder is used as a denoiser. In other words, encoding steps of the encoder are used to remove the film grain of the input frames.

Also, in this embodiment, the region detection (700) is driven by the coding information that is provided at the encoder for encoding the input frames. Thus, additional process for region detection is avoided.

In an embodiment, to detect flat/uniform regions, only Intra Frames where the partitioning and information for each CU are more relevant are considered. In an embodiment, only the luma component is used for the analysis.

When encoding an input frame, each CTU is either processed as one CU or split into multiple CUs by a recursive QT, followed by a recursive binary-ternary tree (BTT), called also muti-type tree (MTT). As described above, the rate distortion (RD) cost of a candidate block is driven by a Quantization Parameter QP. QP defines the quantization level.

At high bitrate and high PSNR, QP value is low while at low bit rate and low PSNR, QP value is high.

For QP values above a given QP value, for instance for QP>=22, the film grain is filtered and not preserved when encoding the input frame. Thus, in this embodiment, the encoding can be considered as a denoiser and is useful to estimate a filtered version of the input frame without film grain. In this case no external denoiser is needed.

In another embodiment, when QP values are higher than the given QP value, for instance QP<22, film grain is no more removed from the input frame when encoding the input frame. Thus, a pre-processing of the input frame is still needed before encoding the input frame to filter and remove the film grain. This denoiser can be any denoiser external to the video coder tools or an internal denoiser, such as an image filtering using or not temporal information, e.g. the MCTF tool of VVC could be used. Thus, in this embodiment, the method illustrated in FIG. 7 comprises an additional pre-processing step of film grain removal. However, the region selection (700) is still based on at least one of the coding parameters obtained for the CUs of the input frame when encoding the input frame.

FIG. 8 illustrates an example of a method for determining film grain parameters according to an embodiment. At 800, a reconstructed image is obtained from an encoding of an input image. As explained above, depending on the QP used for encoding the input image, the input image can have been processed before encoding to remove the film grain or not. At 801, at least one region of the reconstructed image is selected based on at least one coding parameter of the region when encoding the input image. At 802, film grain parameters are determined from the at least one region selected and the input image.

In the following, several embodiments for the region selection process are presented. Embodiments can be used alone or in combination.

### Partitioning Driven Block Selection

The block size selection is highly dependent on the QP value; higher and lower QP values imply selecting larger and smaller block sizes, respectively. Lower QP values preserve the image details, whereas higher QP values provide a higher compression rate at the expense of image quality losses. If the cost is not satisfying for a CU, this CU is split. The higher the QP, the larger the CUs. The uniform regions, with low cost, should be localized in CUs with a large surface.

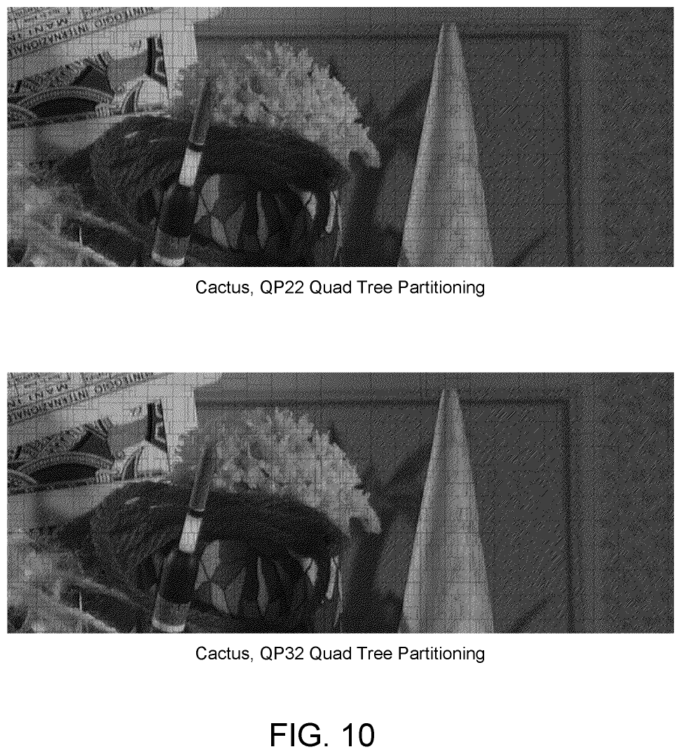

FIG. 10 illustrates an example of quad tree partitioning obtained for QP22 (top) and QP (32) bottom. It can be seen that for a same area in the frame, depending on the QP value, the quad tree partitioning is not the same.

In this embodiment, all small CUs are discarded (i.e. not selected) and only large CUs are analyzed. By small CU, it should be understood a CU have a size that is lower than a given CU size. In a similar manner, a large CU should be understood as a CU having a size larger than a given CU size. For instance, in order to obtain a relevant model of the film grain, a CU block size of 8×8 is too small. Either 32×32 and 16×16 or 64×64 and 32×32 and 16×16 can be considered as good choices.

When determining film grain from large CUs, if the block size is not 64×64, a block scaling to 64×64 is applied. Experiment results show that at least 4 blocks of 64×64 are necessary to have a good estimation of film grain parameters.

### Intra Mode Driven Block Selection

In this embodiment, the Intra Mode coding information is used to check if the CU is coded with orientation information. In VVC, Intra mode coding contains 6 Most Probable Modes. The Planar mode, which is always a Most Probable Mode (MPM), is coded first with a separate flag. The DC and the angular modes are coded using a list of the remaining five MPMs that are derived from intra modes of neighboring blocks. If the intra Mode is coded with angular mode, it means that the block contains coded orientation propagation.

In this embodiment, only CUs coded with at least a DC mode or a planar mode are selected, which correspond to flat blocks, leading to regions with a higher probability to be in uniform regions.

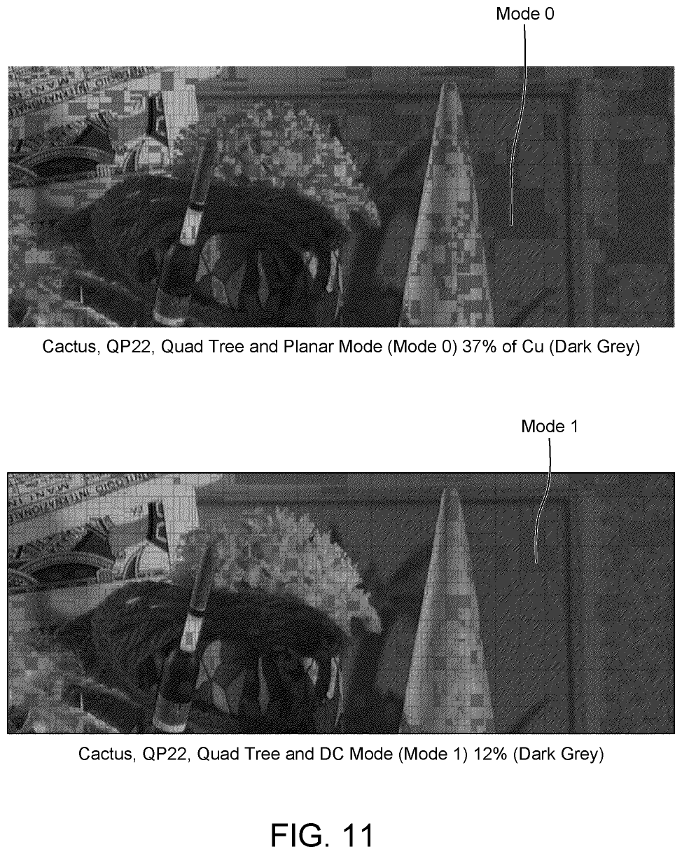

FIG. 11 illustrates examples of intra mode driven block selection based on planar mode (mode 0, top of FIG. 11) and DC mode (mode 1, bottom of FIG. 11). Blocks selected based on this criterion are shown in dark grey in FIG. 11. In these examples, 37% of CU are in planar mode, and 12% are in DC mode.

Depending on the intra prediction mode provided by the encoder and the video compression standard used for encoding the video, other intra prediction modes can be used as long as they correspond to prediction modes of flat regions.

### Residuals Driven Block Selection

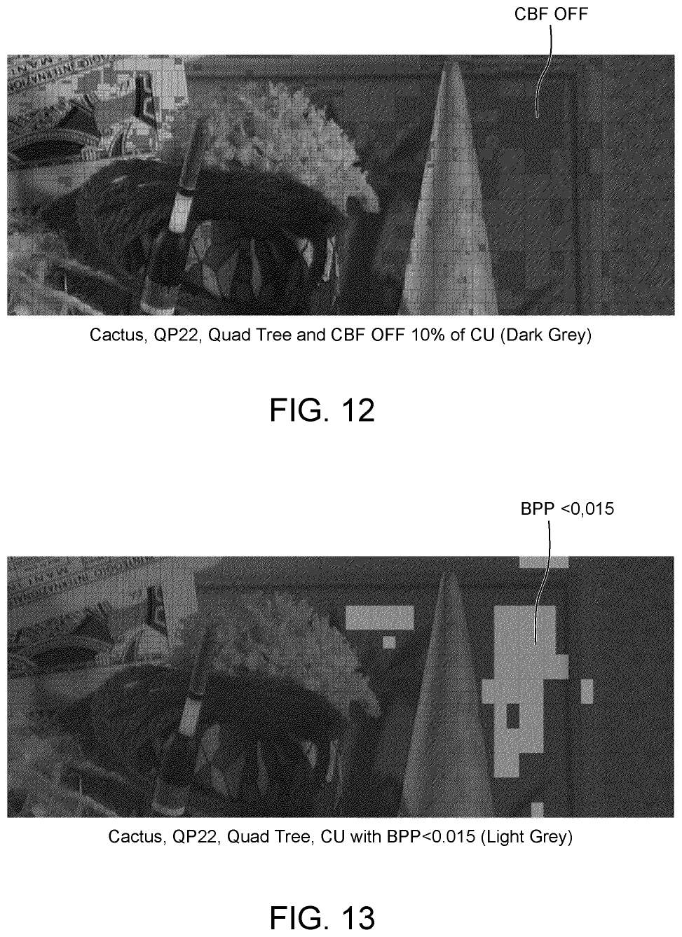

In another embodiment, the Code Block Flag (CBF) is considered for selecting CUs. The CBF is used to indicate whether the encoding result of the CU contains nonzero residuals. If CBF is equal to 0 (OFF), the residual coefficients of the CU do not need to be coded. It means that the coefficients are all 0 and the region can be considered as well predicted. When combined with the embodiment above (intra mode), such regions with CBF at 0 can be considered as having no details, or being uniform. FIG. 12 illustrates examples of residuals driven block selection based on a code block flag value. Blocks selected based on this criterion are shown in dark grey in FIG. 12. In this example, 10% of CU have a CBF to an OFF value.

### Cost Driven Block Selection

Another relevant information that can be used for block selection is the Bit Per Pixel (BPP) cost per CU. The encoding cost of textured regions is higher than for uniform regions. In this embodiment, the CUs that have a low BPP cost are selected, i.e. the CUs that have a BPP cost below a given value are selected. For instance, BPP<0.015 can be a given value to detect uniform region. FIG. 13 illustrates an example of cost driven block selection based on a BPP cost lower than 0.015. Blocks selected based on this criterion are shown in light grey in FIG. 13.

### Coefficients Distribution Driven Block Selection

In this embodiment, the coefficients distribution of transformed coefficients in the block is considered for region selection. Distribution of DCT coefficients or energy of the first n DCT or transformed coefficients also brings some information about uniform regions. If most of the DCT coefficients are in the low frequencies, it means that there is no or not a lot of energy in high frequencies, i.e. there are no details in this CU and the CU can be considered as a uniform region. The percentage of energy in the n first coefficients can be given by:

Let X be the DCT coefficients of the CU, a threshold value for the energy is set, for instance a value of 90% of the energy is considered: EnergyTh=0.9.

The total energy of the block is determined by summing the energy of all coefficients, for instance using an L2:

Xsort=sort(abs(X))

energyTot=normL2(Xsort).

The sort( ) function sorts all DCT coefficients of the CU from the smallest frequency to the highest frequency. The abs( ) function returns the absolute values of the coefficients. The normL2( ) function calculates the square root of the sum of squares of the elements. It provides the energy of the Xsort vector.

Then, a loop is performed on all the coefficients from the low frequency to the high frequency, and for each coefficient c, it is checked whether the sum of the energy of all coefficients from the first coefficient to coefficient c with respect to total energy of the block is below the energy threshold:

$$\begin{matrix}coeffldx = 1 \\ while normL 2 ( Xsort ( 1 : coeffldx ) ) ) / energyTot < EnergyTh : \\ coeffldx = coeffldx + 1\end{matrix}$$

This function returns coeffIdx, i.e., the index of the DCT coefficient for which 90% of the energy can be found in previous lower DCT coefficients. If coeffIdx is low, it means that the energy is in the first/low frequencies, i.e., this CU is a uniform region. The coeffIdx is considered low when the coeffIdx is below a given percentage of the number of coefficients in the block.

In a variant, the coefficients distribution can be determined using the last_xy_sig flag that gives a similar information. This flag corresponds to the position (x,y) of the last significant DCT coefficient in the CU. If (x,y) is close to the top left position in the CU, the energy of the DCT coefficients is concentrated in low frequencies, i.e., this CU is a uniform region. In a same manner as above, the position of the last significant coefficient is considered close to the top left position in the CU when the position of the last significant coefficient is before a given position in the CU. The given position can depend on the size of the CU.

Embodiments described above for selecting regions used for determining film grain parameters can be used alone or two or more embodiments can also be used in combination.

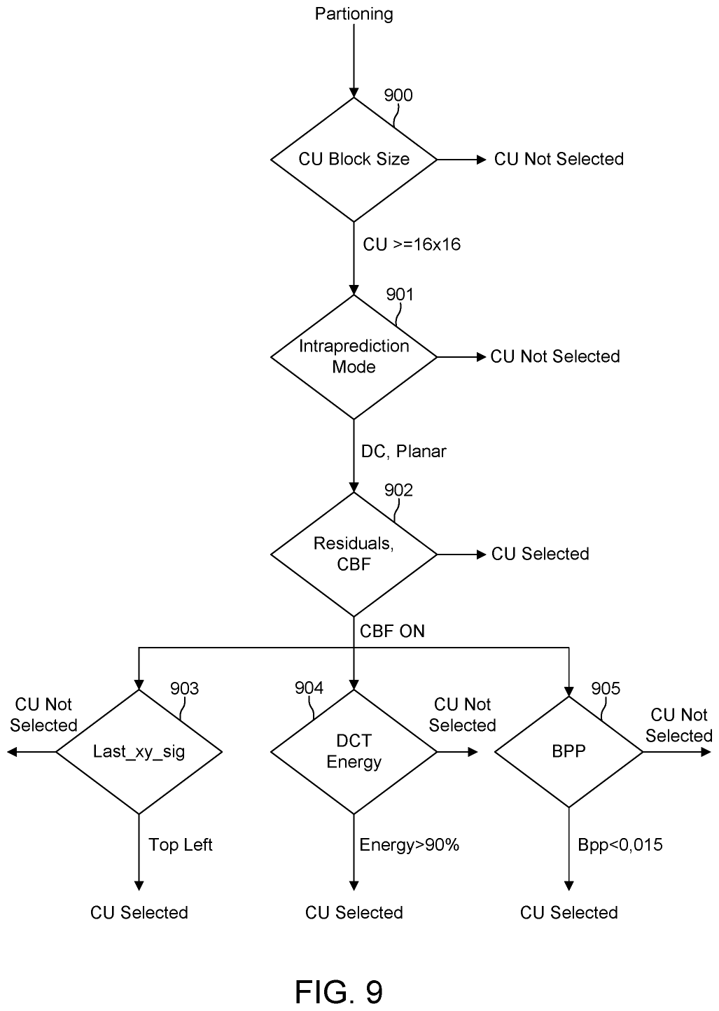

FIG. 9 illustrates an example of a method for determining regions used for determining film grain parameters according to an embodiment.

When encoding a CU of a frame, at 900, the partitioning of the frame is used to check the size of the CU. Responsive to a determination that the size of the CU is below a given size, for instance if the CU size is below 16×16, the CU is not selected and the process ends for this CU. Checking the size of the CU could comprise checking whether the CU is a square CU or not and when the CU is square, whether the CU is below a given size.

In another variant, checking the size could also comprise when the CU is not square, i.e. the CU is rectangular, whether the smallest dimension of the CU is below a given value. For instance, it is checked for rectangular CU, if the smallest dimension among the width and height of the CU is below a given value, such as 16, 32 or 64.

If at 900, it is determined that the size of the CU is above than or equals to the given size value, than at 901, the intra mode prediction used for coding the CU is checked. Responsive to a determination that the intra mode prediction is not a DC mode or a planar mode, then the CU is not selected and the process ends for this CU. Otherwise, the CU is selected.

At 902, it is checked whether residuals are encoded for the current CU. For instance, the value of the CBF is checked. Responsive to a determination that the CBF has a value 0 (OFF, that is no residuals are encoded for the CU), then the CU is selected and the process ends.

Otherwise (CBF value is 1, ON), depending on variants, other coding parameters can be checked for the CU.

At 903, the last_xy_flag is checked. If the last_xy_flag is close to the top left position of the CU, then the CU is selected. Otherwise, the CU is not selected and the process ends.

In another variant, at 904, the energy of the N first coefficients of the CU is checked and if it is determined that the energy of the N first coefficients of the CU is above than or equal to a given amount of the energy of the whole CU (taking into account all the coefficients of the CU), then the CU is selected, N being here a given umber of coefficients considered at low frequency. N can depend on the CU size.

In another variant, at 905, the bit per pixel cost is checked for the CU and if it is determined that the BPP cost of the CU is below a given value, then the CU is selected.

In another variant, the determination at 903, 904 and 905 can be performed subsequently if the CU is not selected from a previous determination.

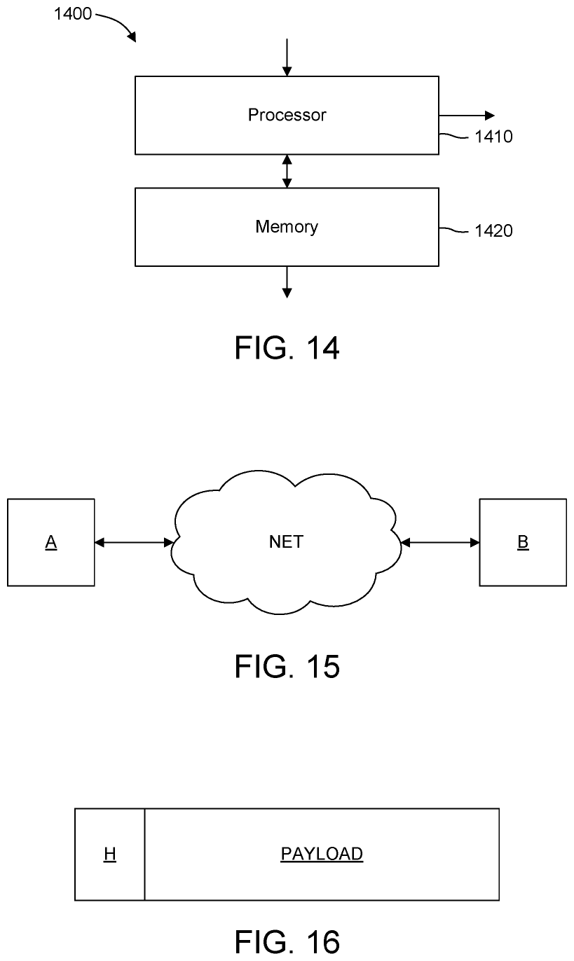

FIG. 14 illustrates a block diagram of a system within which aspects of the present embodiments may be implemented, according to another embodiment. FIG. 14 shows one embodiment of an apparatus 1400 for determining film gran parameters or for selecting regions for determining film grain parameters, according to any one of the embodiments described herein.

The apparatus comprises Processor 1410 and can be interconnected to a memory 1420 through at least one port. Both Processor 1410 and memory 1420 can also have one or more additional interconnections to external connections.

Processor 1410 is also configured to either obtain a reconstructed image from an encoding of an input image, select at least one region of the reconstructed image based on at least one coding parameter of the region when encoding the input image, and determine film grain parameters from the at least one region selected and the input image, using any one of the embodiments described herein. For instance, the processor 1410 is configured using a computer program product comprising code instructions that implements any one of embodiments described herein.

In an embodiment, illustrated in FIG. 15, in a transmission context between two remote devices A and B over a communication network NET, the device A comprises a processor in relation with memory RAM and ROM which are configured to implement a method for encoding a video, as described with FIG. 1, 2, 7 and the device B comprises a processor in relation with memory RAM and ROM which are configured to implement a method for decoding a video as described in relation with FIGS. 1, 3, 7. Depending on embodiments, the device A is also configured for determining film grain parameters or selecting regions for determining film grain parameters as described in relation with FIGS. 4-13. In some embodiments, the device B is also configured for synthesizing film grain on the received video using the received film grain metadata. In accordance with an example, the network is a broadcast network, adapted to broadcast/transmit encoded video and film grain metadata from device A to decoding devices including the device B.

FIG. 16 shows an example of the syntax of a signal transmitted over a packet-based transmission protocol. Each transmitted packet P comprises a header H and a payload PAYLOAD. In some embodiments, the payload PAYLOAD may comprise coded video data encoded and film grain metadata according to any one of the embodiments described above.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decode re-sampling filter coefficients, re-sampling a decoded picture.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of re-sampling filter coefficients. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

1. A method comprising:
obtaining a reconstructed image from an encoding of an input image,
selecting at least one region of the reconstructed image based on at least one coding parameter of the at least one region when encoding the input image, and
determining one or more film grain parameters from the at least one region and the input image.

2. An apparatus, comprising one or more processors, wherein the one or more processors is operable to:
obtain a reconstructed image from an encoding of an input image,
select at least one region of the reconstructed image based on at least one coding parameter of the at least one region when encoding the input image, and
determine one or more film grain parameters from the at least one region and the input image.

3. The apparatus of claim 2, wherein the at least one region is a coding unit, and wherein the at least one coding parameter is at least one of or a combination of two or more of:
a size of the coding unit used for encoding the coding unit,
an intra prediction mode used for encoding the coding unit,
a code block flag indicating whether an encoding of the coding unit provides non-zero residuals,
a bit per pixel cost used for encoding the coding unit,
a position in the coding unit of a last significant coefficient, and
an index of a first coefficient for which a given percentage of energy of the coefficients of the coding unit is obtained by coefficients located before the first coefficient.

4. The apparatus of claim 3, wherein the at least one region is selected responsive to a determination that a size of the at least one region is greater than or equal to a given coding unit size.

5. The apparatus of claim 3, wherein the at least one region is selected responsive to a determination that the intra prediction mode is a DC mode or a planar mode.

6. The apparatus of claim 3, wherein the at least one region is selected responsive to a determination that the code block flag indicates that the encoding of the coding unit provides zero residuals.

7. The apparatus of claim 3, wherein the at least one region is selected responsive to a determination that the bit per pixel cost is greater than or equal to a given value.

8. The apparatus of claim 3, wherein the at least one region is selected responsive to a determination that a distance between a top left position in the coding unit and the position in the coding unit of the last significant coefficient is less than or equal to a given value.

9. The apparatus of claim 3, wherein the at least one region is selected responsive to a determination that a distance between a top left position in the coding unit and the position in the coding unit of the first coefficient for which a given percentage of the energy is provided by the coefficients located between the top left position and the first coefficient, is less than or equal to a given value.

10. The apparatus of claim 2, wherein the input image is encoded as an intra picture.

11. The apparatus of claim 2, wherein the at least one coding parameter obtained from an encoding of a luma component of the input image.

12. The apparatus of claim 2, wherein obtaining the reconstructed image comprises removing film grain from the input image.

13. The apparatus of claim 12, wherein responsive to a determination that a value of a quantization parameter used for encoding the input image is greater than or equal to a given value, removing film grain from the input image is performed by the encoding of the input image at the quantization parameter.

14. The apparatus of claim 12, wherein responsive to a determination that a value of a quantization parameter used for encoding the input image is less than a given value, removing film grain from the input image is performed by denoising the input image using an external denoiser or an image filtering tool of a video encoder.

15. A computer readable storage medium having stored thereon instructions for causing one or more processors to perform the method of claim 1.

16. (canceled)

17. The method of claim 1, wherein the at least one region is a coding unit, and wherein the at least one coding parameter is at least one of or a combination of two or more of:
a size of the coding unit used for encoding the coding unit,
an intra prediction mode used for encoding the coding unit,
a code block flag indicating whether an encoding of the coding unit provides non-zero residuals,
a bit per pixel cost used for encoding the coding unit,
a position in the coding unit of a last significant coefficient, and
an index of a first coefficient for which a given percentage of energy of the coefficients of the coding unit is obtained by coefficients located before the first coefficient.

18. The method of claim 17, wherein the at least one region is selected responsive to at least one of a determination that a size of the at least one region is greater than or equal to a given coding unit size, a determination that the intra prediction mode is a DC mode or a planar mode, a determination that the code block flag indicates that the encoding of the coding unit provides zero residuals, or a determination that the bit per pixel cost is greater than or equal to a given value.

19. The method of claim 17, wherein the at least one region is selected responsive to a determination that a distance between a top left position in the coding unit and the position in the coding unit of the last significant coefficient is less than or equal to a given value.

20. The method of claim 17, wherein the at least one region is selected responsive to a determination that a distance between a top left position in the coding unit and the position in the coding unit of the first coefficient for which a given percentage of the energy is provided by the coefficients located between the top left position and the first coefficient, is less than or equal to a given value.
